(19) United States
(12) Patent Application Publication
(10) Pub. No.: US 2008/0156154 A1
(43) Pub. Date: Jul. 3, 2008

(54) LATHE

(75) Inventors: Yoshitane UEMURA, Yamatokoriyama-shi (JP); Koji KAWASAKI, Yamatokoriyama-shi (JP); Daigo YAMAMOTO, Yamatokoriyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MORI SEIKI CO., LTD, Yamatokoriyama-shi, Nara (JP)

(21) Appl. No.: 11/966,319

(22) Filed: Dec. 28, 2007

(30) Foreign Application Priority Data
Dec. 28, 2006 (JP) 2006-355444

(51) Int. Cl. B23B 23/00

(52) U.S. Cl. 82/148

(57) ABSTRACT

The lathe comprises: a spindle for holding one end side of an annular workpiece W; a rotation drive mechanism for rotating the spindle; and a holding mechanism 20 for holding the other end side of the workpiece W. The holding mechanism 20 comprises: an inserting member 21 which is arranged to rotate freely and of which distal end is inserted into an interior of the other end side of the workpiece W; a support member 28 which supports the inserting member 21 to rotate freely; a plurality of contact members 23 which are arranged on an outer circumferential surface of the distal end of the inserting member 21 and which outwardly protrude to be in contact with an inner circumferential surface of the workpiece W; and a drive mechanism 30 for driving each of the contact members 23 so as to be brought into contact to each other.

### BACKGROUND OF THE INVENTION

1. Technical Field

The present invention relates to a lathe which comprises a spindle which is arranged to rotate freely around an axis line and which holds one end side of an annular workpiece; a rotation drive mechanism for rotating the spindle around the axis line; and a holding mechanism which is arranged to opposite to the spindle in a manner to be kept apart by an interval in an axial direction of the spindle and which holds the other end side of the workpiece, and which is configured to machine an outer circumferential surface of the workpiece.

2. Description of the Related Art

In a case of machining an outer circumferential surface of an annular and lengthy workpiece W, as shown in FIG. 11, it has been conventionally proposed machining by using a lathe disclosed in Japanese Unexamined Patent Application Publication No. 09-066401, for example.

Similar to the general lathe, the lathe is comprised mainly of: a bed; a head stock fixedly provided on the bed; a spindle, supported by the head stock such that an axis line thereof is horizontal and in a manner to rotate freely around the axis line, for holding one end side of the workpiece; a rotation drive mechanism for rotating the spindle around the axis line; a tail stock which is disposed on the bed to opposite to the head stock and moves freely in an axial direction of the spindle; a tail stock spindle which is supported by the tail stock to be coaxial with the axis of the spindle and to rotate freely around the axis line and which supports the other end side of the workpiece; and a tool rest which is disposed on the bed to move freely in the axial direction of the spindle and in a direction orthogonal thereto and which holds a tool. The spindle and the tail stock spindle are attached with holders 101 and 102, respectively, of which distal ends are formed in a manner to taper toward tip ends, as shown in FIG. 11, and the distal ends of the holders 101 and 102 are each inserted internally of the workpiece W. As a result, intersecting sections between an inner circumferential surface and an end surface are held by tapered sections of the holders 101 and 102.

When an outer circumferential surface of the workpiece W is machined by using such a lathe, since the inner circumferential surface of the workpiece W and each of the holders 101 and 102 are linearly in contact, the workpiece W is held such that the workpiece W, the spindle, and the tail stock spindle are arranged coaxially with high precision. Thereby, the machined workpiece W becomes excellent in terms of straightness, circularity, cylindricity, or the like, for example.

Incidentally, as shown in FIG. 11, in some workpieces W, the axis of the workpiece W is not always straight. Due to a precision problem or the like in manufacturing such an annular workpiece W, there are some workpieces W of which axes are curved, as shown in FIG. 12.

However, in the conventional lathe configured such that the both distal ends of each of the holders 101 and 102 are inserted internally of the workpiece W, and the intersecting sections between the inner circumferential surface and the end surface of the workpiece W are held by the tapered sections of the holders 101 and 102, whereby the workpiece W is supported by the spindle and the tail stock spindle, if the workpiece W of which axis is curved is held by each of the holders 101 and 102, the workpiece W is elastically deformed such that the axis becomes straight. As a result, the outer circumferential surface is machined in a state where the workpiece W is elastically deformed, and after the machining is completed, if holding of the workpiece W by each of the holders 101 and 102 is canceled, a shape of the workpiece W is returned to that which is curved before the elastic deformation. Thus, it is not possible to satisfy a required product quality in terms of machining precision such as straightness, circularity, cylindricity, or the like.

Instead of the above-described holders 101 and 102, it is possible to use a first chuck 103 to hold an outer circumferential surface on one end side of the workpiece W and a second chuck 104 to hold an inner circumferential surface on the other end side thereof, as shown in FIG. 13, for example. However, in the case of the workpiece W of which axis is curved, amounts of movement of jaws 104a of the second chuck 104 in a radial direction are the same, and thus, some of the jaws 104a of the second chuck 104 are not in contact with the inner circumferential surface of the workpiece W, thereby generating a gap. As a result, there arises a problem in that the workpiece W cannot be held. Further, when the workpiece W is forcedly held, a problem occurs in which the workpiece W is curved or the workpiece W is elastically deformed as in the case described above.

The present invention has been achieve in view of the circumstances, and an object thereof is to provide a lathe capable of holding a workpiece without deforming the workpiece even in the case of a workpiece of which axis is curved to machine an outer circumferential surface of the workpiece with high precision.

### BRIEF SUMMARY OF THE INVENTION

To achieve the above-described object, the present invention relates to:

a lathe, comprising: a spindle which is arranged to rotate freely around an axis line and which holds one end side of an annular workpiece; a rotation drive mechanism for rotating the spindle around the axis line; and a holding mechanism which is arranged to opposite to the spindle in a manner to be kept apart by an interval in an axial direction of the spindle and which holds the other end side of the workpiece, the lathe configured to machine an outer circumferential surface of the workpiece, wherein

the holding mechanism, comprises:

an inserting member which is arranged to rotate freely around a rotational center axis previously set to be coaxial with the axis line of the spindle and of which at least distal end is insertable into an interior of the other end side of the workpiece;

a support member which supports the inserting member to rotate freely around the rotational center axis;

a plurality of contact members which are provided to be kept apart by previously set intervals in a circumferential direction of an outer circumference of the distal end of the inserting member and which protrude outwardly to be contactable with an inner circumferential surface of the workpiece; and

a drive mechanism which drives each of the contact members to protrude each of the contact members so as to be brought into contact with the inner circumferential surface of the workpiece, wherein

each of the contact members is configured to protrude in a state where a protrusion amount reached when each of the contact members contacts the inner circumferential surface of the workpiece differs to each other.

According to the present invention, one end side of the workpiece is held by the spindle and the other end side of the workpiece is held by the holding mechanism, and as a result, the workpiece is held by the spindle and the holding mechanism. When the other end side of the workpiece is held by the holding mechanism, the workpiece and the inserting member are firstly moved relative to each other so that the both components are approached, allowing the distal end of the inserting member to be inserted into the interior of the other end side of the workpiece. Thereafter, each of the contact members is driven by the drive mechanism so that each of the contact members is protruded, thereby being brought into contact with the inner circumferential surface of the workpiece.

Subsequent thereto, the spindle is rotated around the axis line by the rotation drive mechanism to rotate the workpiece, thereby the outer circumferential surface of the workpiece is machined. At this time, the inserting member is supported by the support member to rotate freely around the rotational center axis, and thus, when the workpiece is rotated, the inserting member, together with the workpiece, is rotated.

In this way, in the lathe according to the present invention, the inner circumferential surface of the workpiece is held by each contact member capable of radially protruding such that each protrusion amount reached when in contact with the inner circumferential surface of the workpiece differs to each other. Therefore, even in the case where the axis line of the workpiece is curved and the interval between the inner circumferential surface of the workpiece and the outer circumferential surface of the inserting member is not constant, the protrusion amount of each contact member changes corresponding to the interval between the workpiece and the inserting member. Thus, by means of the protruded contact members, it becomes possible to hold the inner circumferential surface of the workpiece, without deforming the workpiece. As a result, it is possible to perform machining with high precision even in the case of a workpiece of which axis line is curved. For example, it is possible to sufficiently satisfy a required product quality in terms of straightness, circularity, cylindricity, or the like.

It may be configured such that each of the contact members is formed at a distal end in a protrusion direction with a contact section in contact with the inner circumferential surface of the workpiece and formed at a rear end with a piston section, the inserting member is formed at a distal end thereof with a plurality of cylinder holes into which the piston section of each of the contact members is fitted by insertion to move freely in the protrusion direction and in a direction opposite thereto, and an internal space for communicating each of the cylinder holes with each other on a rear end side of the piston section, and the drive mechanism supplies pressure oil to the internal space of the inserting member to move the piston section in the protrusion direction, whereby the contact section is brought into contact with the inner circumferential surface of the workpiece.

In this way, when the pressure oil is supplied by the drive mechanism to the internal space of the inserting member, the supplied pressure oil is flowed into each cylinder hole to press the rear end side of the piston section of each of the contact members. Thereby, each contact member is outwardly protruded. Each contact member protrudes until the contact section is in contact with the inner circumferential surface of the workpiece. After the contact section contacts the inner circumferential surface of the workpiece, the piston section results in contacting the inner circumferential surface of the workpiece by a force by which the piston section is pressed by the pressure oil. On the other hand, when the supply of the pressure oil by the drive mechanism is stopped, the rear end side of the piston section is not pressed any longer. This brings each contact member in a state where each contact member can be easily retracted by an external force. In this way, when each contact member is protruded by the oil pressure, a protrusion amount of each contact member can be easily controlled.

It may be configured such that each of the contact members is formed at a distal end in a protrusion direction with a contact section in contact with the inner circumferential surface of the workpiece and formed at a rear end with a piston section, the inserting member is formed at a distal end thereof with a plurality of cylinder holes into which the piston section of each of the contact members is fitted by insertion to move freely in the protrusion direction and in a direction opposite thereto, and an internal space for communicating each of the cylinder holes with each other on a rear end side of the piston section, and the drive mechanism comprises: a first piston which is fitted by insertion to move freely in a direction parallel to the rotational center axis in the internal space of the inserting member on an end side rearwardly of a disposing location of the contact member; a first spring body which is disposed between a rear end side of the first piston and the inserting member and which biases the first piston toward the distal end side of the inserting member; hydraulic oil filled in a space enclosed by the piston section of each of the contact members, each cylinder hole, the internal space, and the first piston; and a bias canceling mechanism which moves the first piston toward the rear end side of the inserting member against a biasing force of the first spring body, wherein when the first piston is moved by the first spring body toward the distal end side of the inserting member, a pressure of the hydraulic oil increases, and when the first piston is moved by the bias canceling mechanism toward the rear end side of the inserting member, the pressure of the hydraulic oil decreases.

In this way, the first piston is biased by the first spring body, and as a result, the first piston is moved to the distal end side of the inserting member, whereby the pressure of the hydraulic oil is increased, and the rear end side of the piston section of each contact member is pressed by the hydraulic oil. This protrudes each of the contact members outwardly. Each contact member protrudes until the contact section is in contact with the inner circumferential surface of the workpiece. After the contact section contacts the inner circumferential surface of the workpiece, each contact member contacts the inner circumferential surface of the workpiece by a force by which the piston section is pressed by the hydraulic oil. On the other hand, when the first piston is moved by the bias canceling mechanism to the rear end side of the inserting member against a biasing force of the first spring body, the pressure of the hydraulic oil is decreased, and as a result, a force by which the rear end of the piston section is pressed is decreased. This brings each contact member in a state where each contact member can be easily retracted by an external force. In this way, it becomes again possible to easily control a protrusion amount of each contact member similarly to the above-described case.

In this case, it may be configured such that an interior of the first piston is formed with a pressure adjusting space, the bias canceling mechanism comprises: a second piston which is fitted by insertion to move freely in a direction parallel to the rotational center axis in the pressure adjusting space; and a second spring body which is disposed between a distal end side of the second piston and the first piston and which biases the second piston toward the rear end side of the first piston, and the pressure adjusting space is formed such that the distal end side of the second piston is communicated with the enclosed space filled by the hydraulic oil and a rear end side of the second piston is communicated with an external space.

When the first piston is moved by the bias canceling mechanism to the rear end side of the inserting member against a biasing force of the first spring body, the pressure of the hydraulic oil in the enclosed space is decreased. When the pressure is lowered than that of an atmospheric pressure, it is probable that air may flow into the enclosed space from a gap between the piston section of the contact member and the cylinder holes. Therefore, according to the above-described arrangement, when the first piston is biased by the first spring body, and as a result, the first piston is moved to the distal end side of the inserting member, the distal end side of the second piston is pressed by the hydraulic oil and biased by the second spring body as well, thereby positioning the second piston to the rear end side of the first piston in the pressure adjusting space. However, when the first piston is moved by the bias canceling mechanism to the rear end side of the inserting member against the biasing force of the first spring body, the rear end side of the second piston is pressed by the air corresponding to a decrease in pressure of the hydraulic oil. Thereby, the second piston is moved to the distal end side of the first piston in the pressure adjusting space against the biasing force of the second spring body. As a result, the pressure of the hydraulic oil in the enclosed space is restored. This prevents the pressure of the hydraulic oil from becoming negative, whereby above-described inconvenience can be effectively prevented from occurring.

It may be configured such that each of the contact members is each formed on a distal end surface in the protrusion direction with a groove in parallel with a plane orthogonal to the rotational center axis, the holding mechanism further comprises a returning member which is made of an elastic body formed to be annularly or C-shaped, of which axis line is provided parallel to the rotational center axis, and which is engaged with the groove of each of the contact members, and the returning member deforms elastically to permit a protrusion of each of the contact members and retracts each of the contact members by a shape recovery effect.

In this way, each of the contact members protruded by the drive mechanism can be easily retracted by the returning member, and thus, it is favorable when the distal end of the inserting member inserted into the interior of the other end side of the workpiece is removed from the workpiece.

As described above, according to a lathe of the present invention, it is possible to hold a workpiece without elastically deforming it, and to machine with high precision an outer circumferential surface of the workpiece even in the case of a workpiece of which axis line is curved, and thus, it is possible to increase accuracy of straightness, circularity, cylindricity, or the like, for example.

### BRIEF DESCRIPTION OF THE SEVERAL VIEWS OF THE DRAWINGS

FIG. 1 is a front view showing a schematic configuration of a lathe according to one embodiment of the present invention;

FIG. 2 is a cross-sectional view showing a schematic configuration of a holding mechanism according to the embodiment.

FIG. 3 is a cross-sectional view as viewed in the arrow A-A direction in FIG. 2;

FIG. 4 is a cross-sectional view as viewed in the arrow B-B direction in FIG. 2;

FIG. 5 is a cross-sectional view showing a schematic configuration of the holding mechanism according to the embodiment, and is a view showing a state where a workpiece of which axis line is curved is held;

FIG. 6 is a cross-sectional view as viewed in the arrow C-C direction in FIG. 5;

FIG. 7 is a cross-sectional view as viewed in the arrow D-D direction in FIG. 5;

FIG. 8 is a cross-sectional view showing a schematic configuration of the holding mechanism according to the embodiment, and is a view showing a state where each contact member is retracted;

FIG. 9 is a cross-sectional view as viewed in the arrow E-E direction in FIG. 8;

FIG. 10 is a cross-sectional view as viewed in the arrow F-F direction in FIG. 8;

FIG. 11 is an explanatory diagram explaining a workpiece holding structure according to the conventional example;

FIG. 12 is an explanatory diagram explaining the workpiece holding structure according to the conventional example; and

FIG. 13 is an explanatory diagram explaining the workpiece holding structure according to the conventional example.

### DETAILED DESCRIPTION OF THE INVENTION

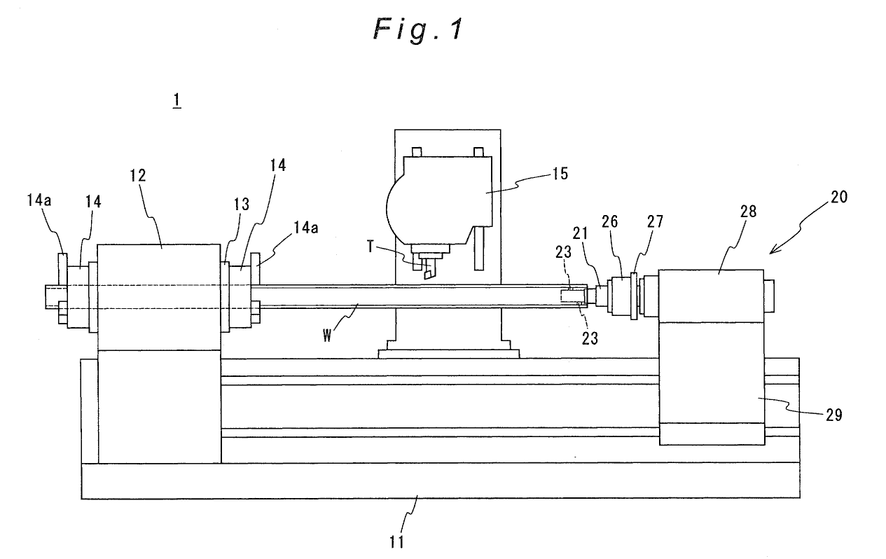

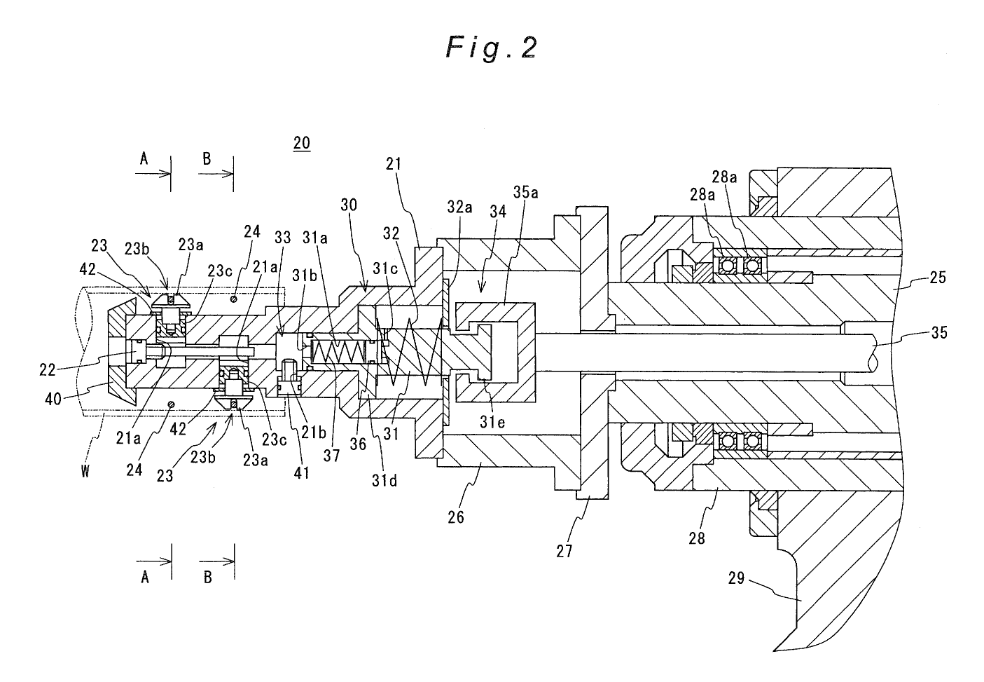

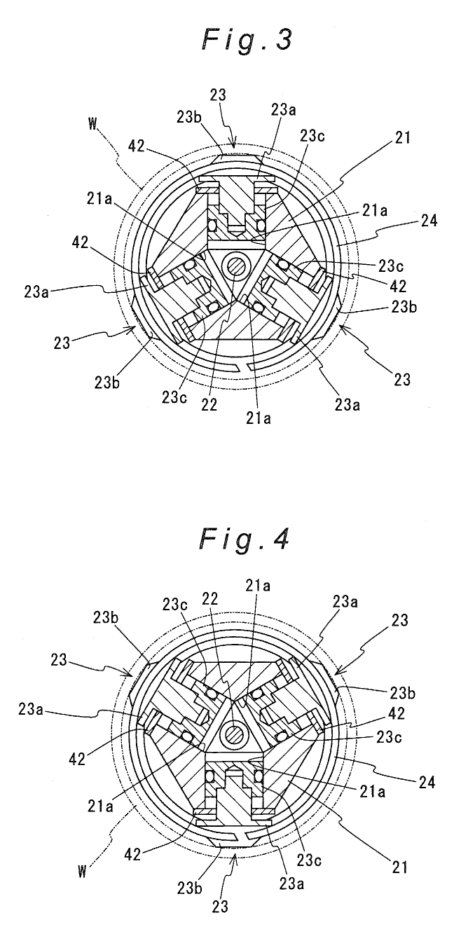

Hereinafter, a preferred embodiment of the present invention will be described with reference to the accompanying drawings. FIG. 1 is a front view showing a schematic configuration of a lathe according to one embodiment of the present invention. FIG. 2 is a cross-sectional view showing a schematic configuration of a holding mechanism according to the embodiment. FIG. 3 is a cross-sectional view as viewed in the arrow A-A direction in FIG. 2. FIG. 4 is a cross-sectional view as viewed in the arrow B-B direction in FIG. 2.

As shown from FIG. 1 to FIG. 4, a lathe 1 of the embodiment is configured to machine an outer circumferential surface of an annular workpiece W. The lathe 1 is provided with: a bed 11; a head stock 12 fixedly provided on the bed 11; a spindle 13, which is supported by the head stock 12 such that an axis line thereof is horizontal and in a manner to rotate freely around the axis line, for holding one end side of the workpiece W; a rotation drive mechanism (not shown) for rotating the spindle 13 around its axis line; a holding mechanism 20, which is disposed on the bed 11 to opposite to the head stock 12, and is arranged to move freely in an axial direction of the spindle 13, for holding the other end side of the workpiece W; a tool rest 15, which is disposed on the bed 11 to move freely in the axial direction of the spindle 13 and in a direction orthogonal thereto, for holding a tool T; a first feeding mechanism (not shown) for moving the holding mechanism 20 in the above-described direction; a second feeding mechanism (not shown) for moving the tool rest 15 in each of the above-described directions; a controlling device (not shown) for controlling operations of the holding mechanism 20, the rotation drive mechanism, and the first and second feeding mechanisms; and other relevant components.

The spindle 13 is formed to be in a cylindrical shape of which interior is hollow, and is arranged such that both ends protrude from the head stock 12. The both ends of the spindle 13 are each attached with chucks 14 which are provided with a plurality of holding jaws 14a and which hold an outer circumferential surface on one end side of the workpiece W by the holding jaws 14a. It is noted that the reason for holding the one end side of the workpiece W by the two chucks 14 is to hold the lengthy workpiece W horizontally.

The holding mechanism 20 is disposed to opposite to the spindle 13 to be kept apart by an interval in the axial direction of the spindle 13. The holding mechanism 20 is formed of: an inserting member 21 configured such that part (distal end) on a side to opposite to the spindle 13 is insertable into an interior on the other end side of the workpiece W; a plurality of contact members 23 arranged on an outer circumferential surface of the distal end of the inserting member 21 and configured to outwardly protrude to be contactable with an inner circumferential surface of the workpiece W; a returning member 24, which is formed of a C-shaped elastic body configured to expand and contract freely in a radial direction and which is engaged with each of the contact members 23, for retracting each of the outwardly protruded contact members 23; a rotational shaft 25 disposed coaxially of the axis line of the spindle 13 and arranged to rotate freely around the axis; a first linkage member 26 and a second linkage member 27 for linking a rear end of the inserting member 21 and the rotational shaft 25; a support member 28 which supports the rotational shaft 25 via a bearing 28a to rotate freely around the axis; a saddle 29, which is disposed on the bed 11 to move freely in the axial direction of the spindle 13, for supporting the support member 28; and a drive mechanism 30 which drives each of the contact members 23 to protrude each of the contact members 23, thereby being brought into contact with the inner circumferential surface of the workpiece W.

The inserting member 21 is formed such that an interior thereof is formed in a hollow cylindrical shape and such that an opening at a distal end thereof is sealed by a sealing member 22. The inserting member 21 is formed such that a cross-sectional shape thereof on the distal end side is equilateral hexagonal, a cross-sectional shape thereof from a center portion side to a rear end side is circular, and an outer center of the equilateral hexagon and the axis line of the spindle 13 are coincident with a center of the circle and the axis line of the spindle 13, respectively. A planar portion of an outer circumference of the distal end of the inserting member 21 is provided with a plurality of cylinder holes 21a which penetrate from an inner circumferential surface to the outer circumferential surface. The cylinder holes 21a are formed such that angles of disposition around the outer center are placed at equal intervals. The outer center of the equilateral hexagonal and the center of the circle act as a rotational center axis when the inserting member 21 is rotated.

Each of the contact members 23 is configured to radially protrude in a direction orthogonal to the outer center. In each of the contact members 23, a contact section 23a in contact with the inner circumferential surface of the workpiece W is provided at a distal end in the protrusion direction, and a piston section 23c fitted by insertion into the cylinder hole 21a to move freely in the protrusion direction and in a direction opposite thereto is provided at a rear end in the protrusion direction. A distal end surface of the contact section 23a is formed with a slit-shaped groove 23b of which lengthwise direction is parallel to a plane orthogonal to the outer center. A plurality of (in the embodiment, 3 pieces) contact members 23 are disposed to be kept apart at equal intervals in a circumferential direction of the inserting member 21, and are disposed at a plurality of (in the embodiment, two locations) locations in a direction along the outer center.

In the contact members 23, rear end surfaces of the piston sections 23c are formed to be the same in area, respectively. In the contact member 23, a plane surface (a plane surface which configures the equilateral hexagon) on which the contact member 23 is disposed is differed depending on a location where it is disposed in the direction along the outer center. In the embodiment, the contact member 23 is configured by two members, that is, a first member formed of the contact section 23a or the like, and a second member formed of the piston section 23c.

The returning member 24 is arranged such that an axis line thereof is arranged coaxially of the outer center and it is engaged with the groove 23b of the contact section 23a of each contact member 23. The returning member 24 is configured to be elastically deformed to permit the protrusion of each contact member 23 and to retract each contact member 23 by a shape recovery effect.

The first linkage member 26 is formed to be in a cylindrical shape of which interior is hollow. One end of the first linkage member 26 is connected to the rear end of the inserting member 21. The second linkage member 27 is formed to be annular and tabular, and one end surface thereof is connected to the other end of the first linkage member 26 and the other end surface thereof is connected to a distal end surface of the rotational shaft 25. The first linkage member 26 and the second linkage member 27 are disposed coaxially of the rotational shaft 25.

The drive mechanism 30 is provided with: a first piston 31 which is fitted by insertion to move freely in the axial direction of the spindle 13 in an internal space of the inserting member 21 on an end side of the inserting member 21 rearwardly of a disposing location of each contact member 23; a first spring body 32 for biasing the first piston 31 toward the distal end side of the inserting member 21; hydraulic oil (not shown) filled in a space 33 enclosed by the piston section 23c of each contact member 23, each cylinder hole 21a, the hollow section of the inserting member 21, and the first piston 31; and a bias canceling mechanism 34 for moving the first piston 31 toward the rear end side of the inserting member 21 against a biasing force of the first spring body 32.

The first piston 31 is provided with: a pressure adjusting space 31a formed internally of a distal end side thereof (distal end side of the inserting member 21); a first communicating hole 31b which opens to a distal end surface and the pressure adjusting space 31a; a second communicating hole 31c which opens to an outer circumferential surface and the pressure adjusting space 31a; a collar 31d formed in a center portion; and an engaging section 31e formed in a rear end. The first spring body 32 is disposed between the collar 31d and an annular section 32a formed in the rear end of the inserting member 21.

The bias canceling mechanism 34 is provided with an engaging rod 35 which includes at a distal end thereof an engaging section 35a engageable with the engaging section 31e of the first piston 31 and which is disposed to move freely in the axial direction of the spindle 13; an engaging rod drive mechanism (not shown) for moving the engaging rod 35 in the above-described direction; a second piston 36 fitted by insertion into the pressure adjusting space 31a of the first piston 31 to move freely in the same direction as the moving direction of the first piston 31; and a second spring body 37 which is disposed in the pressure adjusting space 31a of the first piston 31 and which biases the second piston 36 toward a rear end side of the first piston 31.

The second piston 36 is configured to move in the pressure adjusting space 31a insofar as not to seal each of the communicating holes 31b and 31c. Between a distal end side (distal end side of the inserting member 21) of the second piston 36 and the pressure adjusting space 31a, the hydraulic oil in the enclosed space 33 flows from the first communicating hole 31b. Between a rear end side of the second piston 36 and the pressure adjusting space 31a, air flows from the second communicating hole 31c. The second spring body 37 is disposed between the distal end side of the second piston 36 and the first piston 31.

The distal end of the inserting member 21 is attached with a protection member 40 of which outer circumferential surface is formed in a manner to greatly project outwardly in an amount equal to or greater than that of the non-protruding contact member 23 and which is formed in a manner tapering toward a tip end of the protection member 40. The provision of such protection member 40 effectively prevents the workpiece W from being damaged, which results from a contact between the workpiece W and the contact member 23 at the time that the inserting member 21 is inserted into the interior of the workpiece W of which axis line is curved.

The inserting member 21 is formed with a plurality of screw holes 21b which open to an outer circumferential surface and the enclosed space 33. The screw holes 21 b are each fitted together with pressure adjusting bolts 41. When an amount by which the pressure adjusting bolts 41 is screwed is adjusted, the volume of the enclosed space 33 is adjusted. As a result, a pressure of the hydraulic oil filled in the enclosed space 33 is adjusted.

On the outer circumferential surface of the inserting member 21, there is attached a plate-shaped stopper 42 which contacts the piston section 23c of the contact member 23 to regulate movement of the contact member 23 in a protrusion direction. The first feeding mechanism moves the saddle 29 in the above-described direction, and the controlling device controls an operation of the engaging rod drive mechanism of the bias canceling mechanism 34.

According to the thus configured lathe 1 of the embodiment, the outer circumferential surface of the workpiece W can be machined as described below, for example. Firstly, one end side of the workpiece W is held by the holding jaws 14a of the both chucks 14, and thereafter, the saddle 29 is moved by the first feeding mechanism in a direction which approaches the head stock 12, and the distal end of the inserting member 21 is inserted into the interior of the other end side of the workpiece W. This leads to a state where the outer circumferential surface of the inserting member 21 and the inner circumferential surface of the workpiece W are kept apart by an interval.

Thereafter, the engaging rod 35 is moved by the engaging rod drive mechanism in a direction which approaches the inserting member 21. Thereby, the first piston 31 is biased by the first spring body 32, and as a result, the first piston 31 is moved to the distal end side of the inserting member 21, whereby a pressure of the hydraulic oil in the enclosed space 33 is increased, and the rear end side of the piston section 23c of each contact member 23 is pressed by the hydraulic oil. In the end, each contact member 23 protrudes outwardly while elastically deforming the returning member 24 so that its diameter is expanded. Each contact member 23 protrudes until the contact section 23a is in contact with the inner circumferential surface of the workpiece W. After the contact section 23a contacts the inner circumferential surface of the workpiece W, each contact member 23 contacts the inner circumferential surface of the workpiece W by a force by which the piston section 23c is pressed by the hydraulic oil.

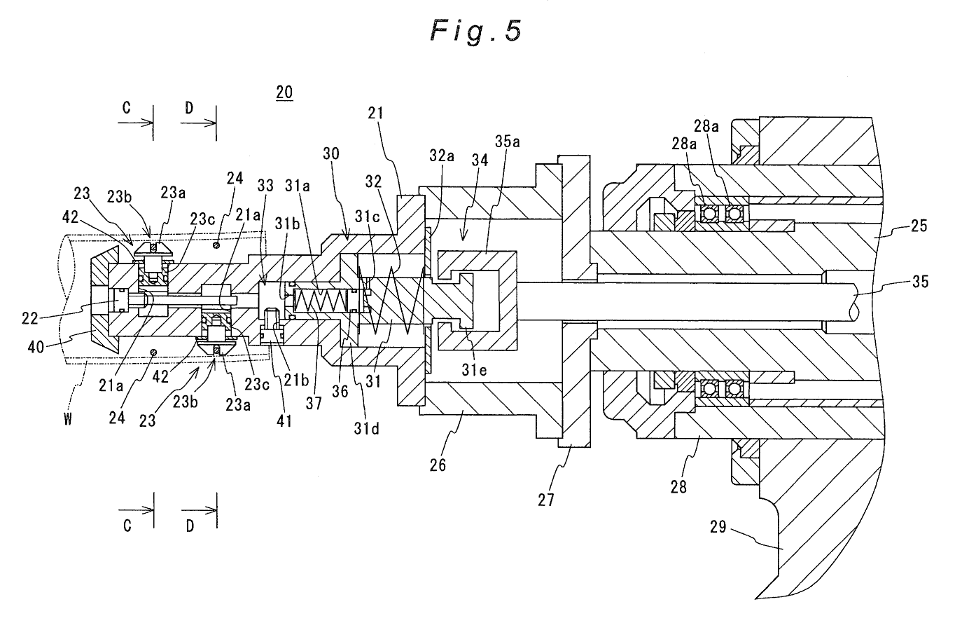

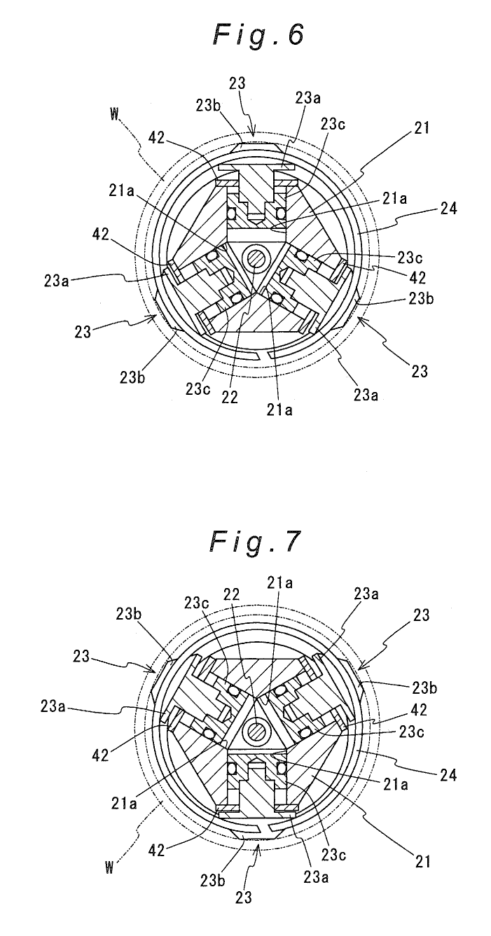

In the case where the axis line of the workpiece W is not curved, a protrusion amount of each contact member 23 is the same, as shown from FIG. 2 to FIG. 4. In the case where the axis line of the workpiece W is curved, a protrusion amount of each contact member 23 differs depending on the interval between the workpiece W and the inserting member 21, as shown from FIG. 5 to FIG. 7. FIG. 5 is a cross-sectional view showing a schematic configuration of the holding mechanism according to the embodiment, and is a view showing a state where the workpiece of which axis line is curved is held. FIG. 6 is a cross-sectional view as viewed in the arrow C-C direction in FIG. 5. FIG. 7 is a cross-sectional view as viewed in the arrow D-D direction in FIG. 5.

In this case, the distal end side of the second piston 36 is pressed by the hydraulic oil in the pressure adjusting space 31a and biased by the second spring body 37, and thus, the second piston 36 is located on the rear end side of the first piston 31 in the pressure adjusting space 31a.

In this way, when the outer circumferential surface on the one end side of the workpiece is held by the spindle 13 (the chuck 14) and the inner circumferential surface of the other end side of the workpiece W is held by the holding mechanism 20, the spindle 13 is rotated around the axis line by the rotation drive mechanism to rotate the workpiece W, and the tool rest 15 is moved by the second feeding mechanism in the axial direction, for example, of the spindle 13 to machine the outer circumferential surface of the workpiece W. At this time, the workpiece W is rotated, and thereby, the inserting member 21, the first linkage member 26, the second linkage member 27, and the rotational shaft 25, together with the workpiece W, are rotated around the axis.

When machining the workpiece W is completed, the engaging rod 35 is moved by the engaging rod drive mechanism in a direction apart from the inserting member 21, and the first piston 31 is moved by the engaging relationship between the engaging section 35a and the engaging section 31e to the rear end side of the inserting member 21 against the biasing force of the first spring body 32. Thereby, the pressure of the hydraulic oil in the enclosed space 33 and the pressure adjusting space 31a is decreased, and thus, a force by which the rear end side of the piston section 23c is pressed is decreased. As a result, each contact member 23 is retracted by the shape recovery effect of the returning member 24.

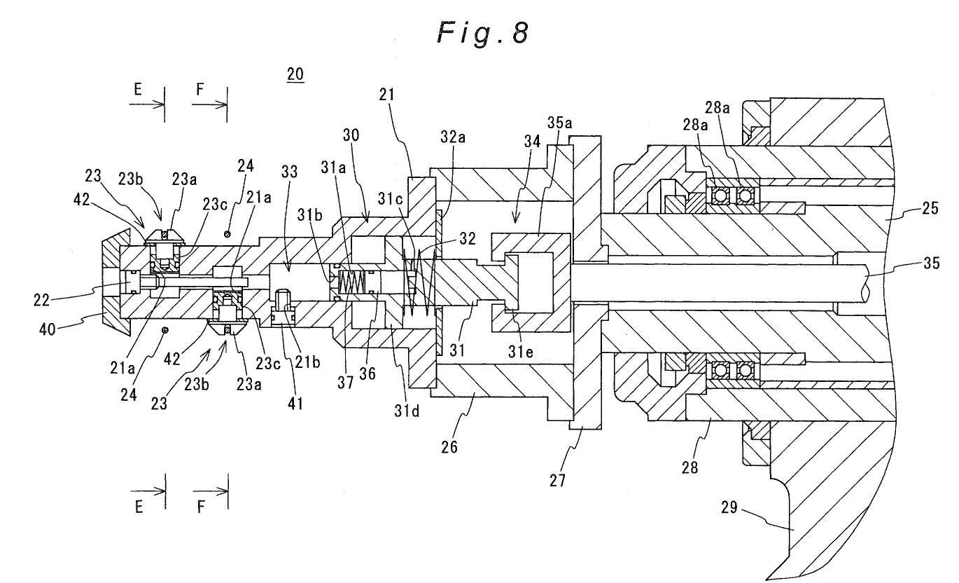

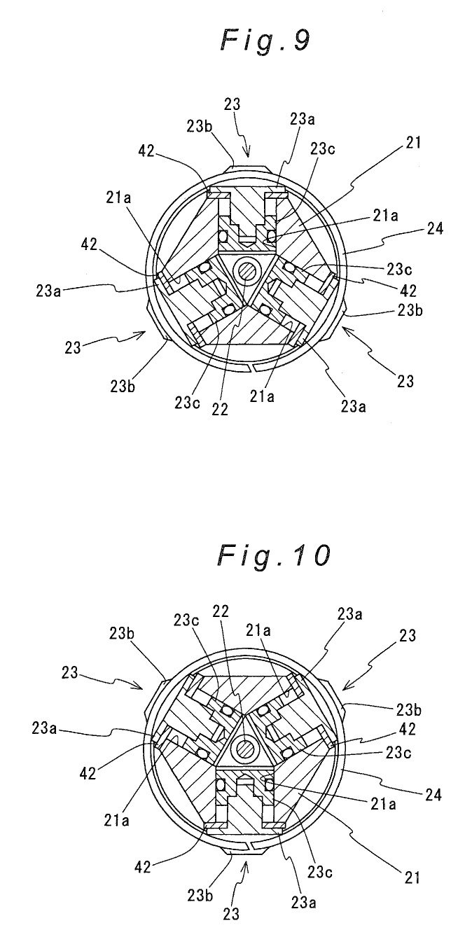

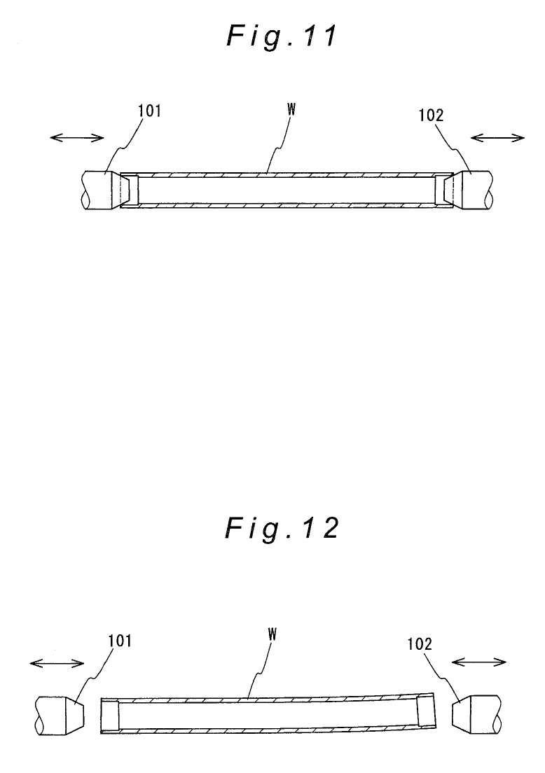

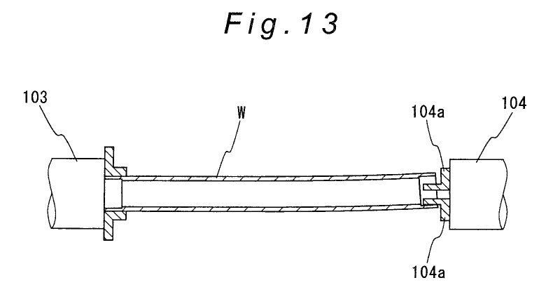

A state at this time is shown from FIG. 8 to FIG. 10. FIG. 8 is a cross-sectional view showing a schematic configuration of the holding mechanism according to the embodiment, and is a view showing a state where each contact member is retracted. FIG. 9 is a cross-sectional view as viewed in the arrow E-E direction in FIG. 8. FIG. 10 is a cross-sectional view as viewed in the arrow F-F direction in FIG. 8.

At this time, since the rear end side is pressed by the air, the second piston 36 is moved to the distal end side of the first piston 31 in the pressure adjusting space 31a, corresponding to a decrease in pressure of the hydraulic oil in the enclosed space 33 and the pressure adjusting space 31a, against the biasing force of the second spring body 37. Thereby, the pressure of the hydraulic oil in the enclosed space 33 and the pressure adjusting space 31a is restored, and thus, the pressure is prevented from being decreased than that of an atmospheric pressure.

Thereafter, the saddle 29 is moved by the first feeding mechanism in a direction apart from the head stock 12, and after removing the distal end of the inserting member 21 from the interior on the other end side of the workpiece W, holding of the outer circumferential surface on the one end side of the workpiece W by each chuck 14 is canceled. This provides a workpiece W in which machining of the outer circumferential surface is completed.

In this way, in the lathe 1 of the embodiment, the inner circumferential surface of the workpiece W is held by each contact member 23 capable of radially protruding such that each protrusion amount reached when in contact with the inner circumferential surface of the workpiece W differs to each other. Therefore, even when the axis line of the workpiece W is curved and the interval between the inner circumferential surface of the workpiece W and the outer circumferential surface of the inserting member 21 is not constant, the protrusion amount of each contact member 23 changes corresponding to the interval between the workpiece W and the inserting member 21. Thus, by means of the protruded contact members 23, it becomes possible to hold the inner circumferential surface of the workpiece W, without deforming the workpiece W. Thereby, even in the case of the workpiece W of which axis line is curved, it is possible to machine the outer circumferential surface of the workpiece W with high precision while holding the workpiece W without elastically deforming it. For example, it becomes possible to increase accuracy of straightness, circularity, cylindricity, or the like.

Each contact member 23 is protruded by an oil pressure, and thus, the protrusion amount of each contact member 23 can be easily differed while keeping the contact force of each contact member 23 the same.

Further, corresponding to the decrease in pressure of hydraulic oil in the enclosed space 33 and the pressure adjusting space 31a, the second piston 36 is moved against the biasing force of the second spring body 37 to the distal end side of the first piston 31 in the pressure adjusting space 31a, thereby preventing the pressure of the hydraulic oil in the enclosed space 33 and the pressure adjusting space 31a from being decreased than that of the atmospheric pressure. As a result, it becomes possible to effectively prevent inconvenience in which a pressure in the enclosed space 33 becomes negative, and thus, air is flowed into the enclosed space 33 from a gap between the piston section 23c of each contact member 23 and the cylinder hole 21a.

The returning member 24 is engaged internally of the groove 23b of each contact member 23, and thus, each of the protruded contact members 23 can be easily retracted by the returning member 24. This is favorable when removing from the workpiece W the distal end of the inserting member 21 inserted into the interior on the other end side of the workpiece W.

Thus, one embodiment of the present invention has been described above. However, specific modes in which the present invention can be realized are not limited thereto.

In the above-described embodiment, it is configured such that the first piston 31 is moved to increase or decrease the pressure of the hydraulic oil in the enclosed space 33, thereby protruding or retracting each contact member 23. However, the embodiment is not limited thereto. For example, it may be configured such that the drive mechanism 30 is configured by a pressure-oil supply mechanism for supplying pressure oil internally to the hollow section of the inserting member 21, and an operation of the pressure-oil supply mechanism is controlled to protrude each contact member 23 when the pressure oil is supplied internally to the hollow section of the inserting member 21 and to retract each contact member 23 when the supply of the pressure oil internally to the hollow section of the inserting member 21 is stopped.

Further, the surface, which is in contact with the workpiece W, of the contact member 23 may be hemispherically formed instead of being planarly formed as in the embodiment. The cross-sectional shape of the distal end of the inserting member 21 is not limited to an equilateral hexagonal shape, but may be a polygonal shape other than the equilateral hexagon or a circle. The rotational center of the inserting member 21 may not always be set to the outer center of the polygon or the center of the circle. The returning member 24 may be formed to be annular instead of being C-shaped. The rotation drive mechanism may be provided on the holding mechanism 20 side to rotate the workpiece W by the rotation drive mechanism on the spindle 13 side, together with the rotation drive mechanism on the holding mechanism 20 side. In the embodiment, the chucks 14 are provided on the both ends of the spindle 13, and the two chucks 14 are used to hold the one end side of the workpiece W. However, the chuck 14 may be provided only on the holding mechanism 20 side of the spindle 13, and the single chuck 14 may be used to hold the one end side of the workpiece W.

What is claimed is:

1. A lathe, comprising: a spindle which is arranged to rotate freely around an axis line and which holds one end side of an annular workpiece; a rotation drive mechanism for rotating the spindle around the axis line; and a holding mechanism which is arranged to opposite to the spindle in a manner to be kept apart by an interval in an axial direction of the spindle and which holds the other end side of the workpiece, the lathe configured to machine an outer circumferential surface of the workpiece, wherein
the holding mechanism, comprises:
an inserting member which is arranged to rotate freely around a rotational center axis previously set to be coaxially of the axis line of the spindle and of which at least distal end is insertable into an interior of the other end side of the workpiece;
a support member which supports the inserting member to rotate freely around the rotational center axis;
a plurality of contact members which are provided to be kept apart by previously set intervals in a circumferential direction of an outer circumference of the distal end of the inserting member and which protrude outwardly to be contactable with an inner circumferential surface of the workpiece; and
a drive mechanism which drives each of the contact members to protrude each of the contact members so as to be brought into contact with the inner circumferential surface of the workpiece, wherein
each of the contact members is configured to protrude in a state where a protrusion amount reached when each of the contact members contacts the inner circumferential surface of the workpiece differs to each other.

2. The lathe according to claim 1, wherein
each of the contact members is formed at a distal end in a protrusion direction with a contact section in contact with the inner circumferential surface of the workpiece and formed at a rear end with a piston section,
the inserting member is formed at a distal end thereof with a plurality of cylinder holes into which the piston section of each of the contact members is fitted by insertion to move freely in the protrusion direction and in a direction opposite thereto, and an internal space for communicating each of the cylinder holes with each other on a rear end side of the piston section, and
the drive mechanism supplies pressure oil to the internal space of the inserting member to move the piston section in the protrusion direction, whereby the contact section is brought into contact with the inner circumferential surface of the workpiece.

3. The lathe according to claim 1, wherein
each of the contact members is formed at a distal end in a protrusion direction with a contact section in contact with the inner circumferential surface of the workpiece and formed at a rear end with a piston section,
the inserting member is formed at a distal end thereof with a plurality of cylinder holes into which the piston section of each of the contact members is fitted by insertion to move freely in the protrusion direction and in a direction opposite thereto, and an internal space for communicating each of the cylinder holes with each other on a rear end side of the piston section, and
the drive mechanism comprises: a first piston which is fitted by insertion to move freely in a direction parallel to the rotational center axis in the internal space of the inserting member on an end side rearwardly of a disposing location of the contact member; a first spring body which is disposed between a rear end side of the first piston and the inserting member and which biases the first piston toward the distal end side of the inserting member; hydraulic oil filled in a space enclosed by the piston section of each of the contact members, each cylinder hole, the internal space, and the first piston; and a bias canceling mechanism which biases the first piston toward the rear end side of the inserting member against a biasing force of the first spring body, wherein when the first piston is moved by the first spring body toward the distal end side of the inserting member, a pressure of the hydraulic oil increases, and when the first piston is moved by the bias canceling mechanism toward the rear end side of the inserting member, the pressure of the hydraulic oil decreases.

4. The lathe according to claim 3, wherein
an interior of the first piston is formed with a pressure adjusting space,
the bias canceling mechanism comprises a second piston fitted by insertion in the pressure adjusting space to move freely in a direction parallel to the rotational center axis and a second spring body which is disposed between the distal end side of the second piston and the first piston and which biases the second piston toward the rear end side of the first piston; and
the pressure adjusting space is formed such that the distal end side of the second piston is communicated with the enclosed space filled by the hydraulic oil and a rear end side of the second piston is communicated with an external space.

5. The lathe according to claim 1, wherein
each of the contact members is each formed on a distal end surface in a the protrusion direction with a groove in parallel with to a plane orthogonal to the rotational center axis,
the holding mechanism further comprises a returning member which is made of an elastic body formed to be annularly or C-shaped, of which axis line is provided parallel to the rotational center axis, and which is engaged with the groove of each of the contact members, and
the returning member is configured to elastically deform to permit a protrusion of each of the contact members and to retract each of the contact members by a shape recovery effect.
